(19) United States
(12) Patent Application Publication
(10) Pub. No.: US 2025/0128270 A1
(43) Pub. Date: Apr. 24, 2025

(54) SYSTEMS AND METHODS FOR PRECLEANING AIR USING CHARGE PLATES

(71) Applicant: Caterpillar Inc., Peoria, IL (US)

(72) Inventors: Philip Carl Spengler, Washington, IL (US); Franklin Jeffrey Kostecki, O'Fallon, MO (US); Alex Raymond Kuscsik, Gurnee, IL (US); Patrick James White McNulty, Plainfield, IL (US); Stephen Christopher Sheltra, Peoria, IL (US)

(73) Assignee: Caterpillar Inc., Peoria, IL (US)

(21) Appl. No.: 18/492,624

(22) Filed: Oct. 23, 2023

(51) Int. Cl. B03C 3/08; B03C 3/019; B03C 3/15; B03C 3/68; F02M 35/02; F02M 35/10

(52) U.S. Cl. CPC B03C 3/08; B03C 3/019; B03C 3/15; B03C 3/68; F02M 35/0217; F02M 35/10262; B03C 2201/30

(57) ABSTRACT

A filter for filter air for an internal combustion engine and methods of operation are described herein. The air precleaner is configured to use electrostatic attraction or repulsion to move ionized particles towards an inner wall of the air precleaner, where the particles eventually exit the air precleaner through a particle exhaust. The particles are ionized using a positive charge plate and a negative charge plate. The positive charge plate creates a positive charge field, creating positive ions that ionize particles in the air with a positive charge. The negative charge plate creates a negative charge field, creating negative ions that ionize particles in the air with a negative charge. The air precleaner can also include a cyclonic section that causes the air to rotate about a central axis of the air precleaner, imparting a centripetal force on the particles. The centripetal force and the electrostatic force act together to filter the air.

### TECHNICAL FIELD

The present disclosure relates to internal combustion engines, and more particularly, to precleaning air by using charge plates to attract or repel ionized particles in the air.

### BACKGROUND

Internal combustion engines are widely used in various industries. Internal combustion engines can operate on a variety of different liquid fuels, gaseous fuels, and various blends. Spark-ignited engines employ an electrical spark to initiate combustion of fuel and air, whereas compression ignition engines typically compress gases in a cylinder to an autoignition threshold such that ignition of fuel begins without requiring a spark. In an attempt to prolong the lifetime of the engine, the air used for combustion is typically filtered to remove particulate. The particulate, if unfiltered, can cause wear and tear on various engine components and can cause a reduction in performance, or a failure, of the engine eventually. Although various types of filters may be used, a common type of filter is a cellulose-based porous membrane that blocks particles of various sizes, while allowing air to move through for combustion. Another common type of filter is a centrifugal filter, where intake air is rotated to force particles towards the outer walls of the filter while allowing air to progress through a central portion of the filter.

Some efforts have been made to improve on the efficiency of air filters. For example, Chinese Patent CN112610369B to Yu (“the '369 patent”) describes one such effort. The '369 patent is directed to an automobile air filter used for an internal combustion engine. The air fuel filter has an inlet on one side and an outlet on a second side. (Abstract). The air filter of the '369 patent includes in the path of the incoming air an electrostatic dust collection plate. (The '369 patent, paragraph [0026]). The electrostatic dust collection plate is designed to collect smaller particles allowed through a coarse strainer of the air filter. However, the system described in the '369 patent suffers from some shortfalls. For example, as the electrostatic dust collection plate collects particles, as with many air filters, the resistance to air movement through the filter increases, potentially reducing the amount of air moving through the filter and reducing the available power or fuel efficiency of the engine. Further, as with many electrostatic-type filters, the electrostatic-type filter needs to be removed, cleaned, and then reinstalled periodically. The cleaning process can often involve ultrasonic and chemical cleaning processes, increasing the operational cost to use a conventional electrostatic-type filter. Some examples of the present disclosure are directed to overcoming these and other deficiencies of such systems.

### SUMMARY

One aspect of the presently disclosed subject matter describes an air precleaner for precleaning air used for an internal combustion engine the air precleaner comprising an intake section for receiving air from an environment around the air precleaner, wherein the air includes particles, an electrostatic section comprising a positive plate having a positive voltage potential, wherein the positive plate is disposed proximate to an inner wall of the air precleaner, the positive plate configured to create a positive charge field proximate to the inner wall of the air precleaner, wherein the positive charge field is configured to ionize at least a first portion of the particles moving through the air precleaner with a positive charge, and a negative plate having a negative voltage potential relative to the positive voltage potential of the positive plate, wherein the negative plate is disposed proximate to the inner wall of the air precleaner and electrically separated from the positive plate and configured create a negative charge field proximate to the inner wall of the air precleaner, wherein the negative charge field is configured to ionize at least a second portion of the particles moving through the air precleaner with a negative charge, wherein the first portion of the particles are electrostatically attracted to the negative plate and the second portion of the particles are electrostatically attracted to the positive plate to electrostatically force at least a portion of the first portion and at least a portion of the second portion towards the inner wall of the air precleaner, an air exhaust for allowing the air to exit the air precleaner, and a particle exhaust for allowing a portion of the particles ionized by the positive charge field or the negative charge field to exit the air precleaner.

In an additional aspect, the presently disclosed subject matter describes a controller for controlling an air precleaner for an internal combustion engine, the controller comprising a memory storing computer-executable instructions, and a processor in communication with the memory, the computer-executable instructions causing the processor to perform acts comprising detecting the engine is starting up requiring air for combustion, wherein the air includes particles, and issuing a voltage command to a voltage controller of an air precleaner to preclean the air, wherein the air precleaner comprises a positive plate disposed proximate to an inner wall of the air precleaner, the positive plate configured to create a positive charge field proximate to the inner wall of the air precleaner, wherein the positive charge field is configured to ionize at least a first portion of the particles moving through the air precleaner with a positive charge, and a negative plate disposed proximate to the inner wall of the air precleaner and electrically separated from the positive plate and configured create a negative charge field proximate to the inner wall of the air precleaner, wherein the negative charge field is configured to ionize at least a second portion of the particles moving through the air precleaner with a negative charge, and wherein the first portion of the particles are electrostatically attracted to the negative plate and the second portion of the particles are electrostatically attracted to the positive plate, and wherein the voltage command controls a voltage potential as measured between the positive plate and the negative plate.

In a still further aspect, the presently disclosed subject matter describes an air precleaner system for precleaning air for an internal combustion engine, the air precleaner system comprising an air precleaner comprising an intake section for receiving the air from an environment around the air precleaner, wherein the air includes particles, an electrostatic section comprising a positive plate having a positive voltage potential, wherein the positive plate is disposed proximate to an inner wall of the air precleaner, the positive plate configured to create a positive charge field proximate to the inner wall of the air precleaner, wherein the positive charge field is configured to ionize at least a first portion of the particles moving through the air precleaner with a positive charge, and a negative plate having a negative voltage potential relative to the positive voltage potential of the positive plate, wherein the negative plate is disposed proximate to the inner wall of the air precleaner and electrically separated from the positive plate and configured create a negative charge field proximate to the inner wall of the air precleaner, wherein the negative charge field is configured to ionize at least a second portion of the particles moving through the air precleaner with a negative charge, and wherein the first portion of the particles are electrostatically attracted to the negative plate and the second portion of the particles are electrostatically attracted to the positive plate to electrostatically force at least a portion of the first particles and at least a portion of the second portion towards the inner wall of the air precleaner, and a controller comprising a memory storing computer-executable instructions, and a processor in communication with the memory, the computer-executable instructions causing the processor to perform acts comprising, receiving a signal to indicate a change in a flowrate of the air, determining if the positive voltage potential or the negative voltage potential needs to be changed based on the change in the flowrate, and upon determining that the positive voltage potential or the negative voltage potential needs to be changed, issuing a second voltage command to the voltage controller to change the positive voltage potential or the negative voltage potential.

### BRIEF DESCRIPTION OF DRAWINGS

FIG. 1 illustrates a precleaner that uses charge plates to ionize particles, in accordance with various embodiments of the presently disclosed subject matter.

FIG. 2 is a side view illustration of a precleaner that uses charge plates to ionize particles, in accordance with various embodiments of the presently disclosed subject matter.

FIG. 3 is an illustration of a precleaning system in which an electrostatic precleaner is used to clean air for an internal combustion engine, in accordance with various example of the presently disclosed subject matter.

FIG. 4 illustrates a method for operating a precleaning system in which an electrostatic precleaner is used to clean air for an internal combustion engine, in accordance with various examples of the presently disclosed subject matter.

FIG. 5 depicts a component level view of a controller for use with the systems and methods described herein, in accordance with various examples of the presently disclosed subject matter.

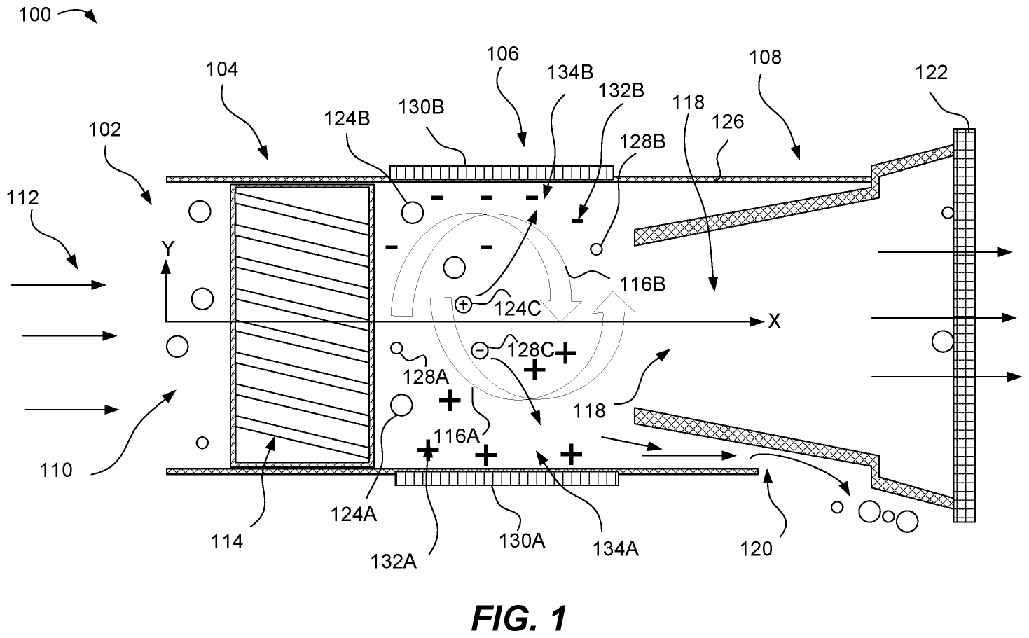

### DETAILED DESCRIPTION

Wherever possible, the same reference numbers will be used throughout the drawings to refer to the same or like parts. FIG. 1 is a cross-section illustration showing an air precleaner 100. As used herein, a “precleaner” does not utilize physical media, such as a porous mesh, upon which particles are trapped. The air precleaner 100 may be used to preclean air for an internal combustion engine, in accordance with various embodiments of the presently disclosed subject matter. The air precleaner 100 is comprised of an intake section 102, a cyclonic section 104 air directional for cyclonic movement, an electrostatic section 106, and an exhaust section 108. It should be noted that various examples of the presently disclosed subject matter do not require all sections, such as by way of example, the cyclonic section 104. The intake section 102 includes an air intake 110 for receiving air 112 from an environment around the air precleaner 100. The air 112 moves along the air precleaner 100 in the general direction of axis X.

The air 112 leaves the intake section 102 and travels into the cyclonic section 104. The cyclonic section 104 includes a series (or plurality) of blades 114 that cause the air 112 to rotate about the axis X, which is generally a central axis of the air precleaner 100, generally represented by centrifugal indicators 116A and 116B. As the air 112 moves through the electrostatic section 106, the air flows into either an air exhaust 118 or a particle exhaust 120. The air 112 flowing into the air exhaust 118 flows through a secondary filter 122. The secondary filter 122 can be any type of filter having a porous membrane that blocks particles of various sizes, while allowing the air 112 to move through for combustion. Some of the air 112, as mentioned above, may also flow through the particle exhaust 120. In some examples, little to no air 112 may flow thru 120. Invention not limited to requiring air thru 120. The air moving through the particle exhaust 120 can include particles filtered through the cyclonic action of the air 112 while rotating in the electrostatic section 106. As the air 112 rotates, the action of the air 112 rotating about the axis X applies a centripetal force in the direction of axis Y to particles in the air 112, such as the particles 124A and 124B. The centripetal force causes the particles 124A and 124B to move towards an inner wall 126 of the air precleaner 100, eventually moving along the inner wall 126 and out through the particle exhaust 120. As noted above, in some examples, the cyclonic section 104 may not be used and the presently disclosed subject matter is not limited to the requirement of a cyclonic section 104.

However, some particles, such as particles 128A and 128B, have a mass small enough that the centripetal force, the primary force used in the air precleaner 100, applied to the particles 128A and 128B is not sufficient to efficiently or effectively force the particles 128A and 128B to the inner wall 126. Thus, these particles 128A and 128B, because of their relatively small mass, have a higher likelihood of remaining with the air 112 and moving into the air exhaust 118. If the pores of the secondary filter 122 are large enough, the particles 128A and 128B may move through the secondary filter 122 and into the combustion engine.

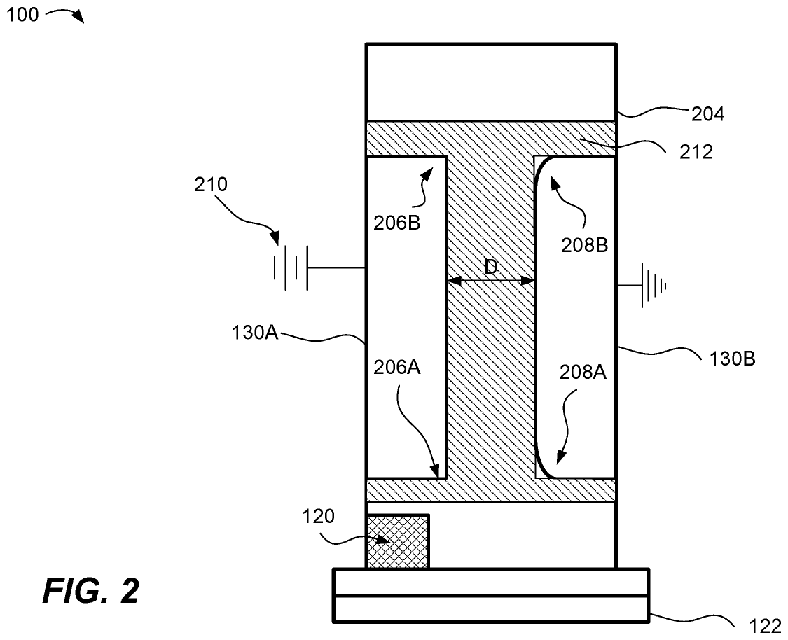

To provide a supplementary force to the centrifugal force for relatively small particles like the particles 128A and 128B, the air precleaner 100 includes the electrostatic section 106. The electrostatic section 106 is designed to charge at least a portion of the particles, including the relatively smaller particles 128A and 128B, and thereafter use electrostatic attraction or repulsion to pull or push the particles, including the relatively smaller particles 128A and 128B, towards to the inner wall 126. It should be noted, however, that some particles, such as the particle 128A or 128B, may already have a charge prior to entering the air precleaner 100 and may be attracted to or repelled from plates in a manner similar to particles that are ionized in the air precleaner 100. The presently disclosed subject matter is not limited to a use on neutral or uncharged particles. The electrostatic portion includes a positive plate 130A and a negative plate 130B. The positive plate 130A and the negative plate 130B are disposed (installed) proximate to the inner wall 126. In some examples, the positive plate 130A and the negative plate 130B form part of the inner wall 126. In other examples, the positive plate 130A and the negative plate 130B are installed or disposed onto an outside portion of the air precleaner 100. It should be noted that the polarities of the positive plate 130A and the negative plate 130B are relative, as the positive plate 130A may be charged by a positive terminal of a power supply and the negative plate 130B may be grounded, illustrated by way of example in FIG. 2, below. In another example, the positive plate 130A may be grounded and the negative plate 130B may be charged by a negative terminal of a power supply.

In the example illustrated in FIG. 1, the positive plate 130A creates positive ions, such as positive ion 132A, in a positive charge field 134A proximate to the inner wall 126. In a similar manner, the negative plate 130B creates negative ions, such as negative ion 132B, in a negative charge field 134B proximate to the inner wall 126. The positive ions 132A and the negative ions 132B collide with the particles, such as the relatively smaller particles 128A and 128B, as well as the particles 124A and 124B, and apply the electrical charge to the particle (ionize the particle) to which the ion collided. For example, the particle 128C, a relatively smaller particle, has collided with a negative ion 132B and has received a negative electrical charge or has been ionized. In another example, the particle 124C, a relatively larger particle, has collided with a positive ion 132A and has received a positive electrical charge, i.e., ionized. In some examples, one or more particles may collide with multiple ions and further build up a charge.

When particles collide with the ions created by either the positive plate 130A or the negative plate 130B, the charge of the particle creates an electrostatic attraction to the charge field of the opposite polarity. For example, the particle 128C has a negative charge. The negative charge is electrostatically attracted to the positive charge field 134A and electrostatically repulsed by the negative charge field 134B. In a similar manner, the particle 124C has a positive charge. The positive charge is electrostatically attracted to the negative charge field 134B and electrostatically repulsed by the positive charge field 134A. The electrostatic attraction acts a supplemental force to the centripetal force imparted on the particles to move at least a portion of the particles towards the inner wall 126, and eventually out thru the particle exhaust 120, increasing the cleanliness of the air 112.

The voltage applied to either the positive plate 130A and/or the negative plate 130B can be adjusted to increase or decrease the strength the positive charge field 134A and negative charge field 134B, respectively. The increasing of the strength of the positive charge field 134A and/or negative charge field 134B can increase or decrease the probability of ionizing a particle as well as increasing the electrostatic attractive or repulsive force to move the ionized particles to the inner wall 126 for precleaning, as illustrated in FIG. 2.

FIG. 2 is a side view illustration of the air precleaner 100 of FIG. 1, in accordance with various embodiments of the presently disclosed subject matter. The air precleaner 100 includes the positive plate 130A and the negative plate 130B. The positive plate 130A and the negative plate 130B extend along at least a portion of an outer wall 204 of the air precleaner 100. The positive plate 130A and the negative plate 130B are electrically separated, wherein a current does not flow directly from the positive plate 130A to the negative plate 130B. The positive plate 130A and the negative plate 130B are also separated by a distance D to reduce a probability of shorts or arcing between the positive plate 130A and the negative plate 130B. In some examples, as illustrated in FIG. 2, the positive plate 130A and/or the negative plate 130B can be shaped to reduce the probability of shorts or arcing between the positive plate 130A and the negative plate 130B. In some instances, charges can build up at sharp or generally rectangular or square corners of a shape. Because of the steady-state requirement that the electric field be normal to the surface of the conductor (and zero inside), regions where the surface has a small radius of curvature (i.e., points and corners) have a high divergence of the field, which from Gauss' Law means a significant local charge density. In some examples, an insulating material 212 may be used to provide the distance D. The insulating material 212 may be plastic, rubber, or other material with insulating properties that may be sized and/or shaped to reduce a probability of a short or arc between the positive plate 130A and the negative plate 130B. As noted above, however, other technologies may be used to reduce a probability of a short or arc between the positive plate 130A and the negative plate 130B, including, but not limited to, shaping one or more of the plates.

For example, in FIG. 2, the positive plate 130A includes the corners 206A and 206B. As the air precleaner 100 operates, positive charges may build up at the corners 206A and 206B along the inner wall 126. The building up of particles can potentially overcome the electrical resistance between the positive plate 130A at the corners 206A and 206B and the negative plate 130B proximate to the corners 206A and 206B, potentially causing shorts or arcing at those locations. This can reduce the amount of voltage that can be used to operate the air precleaner 100, thus potentially reducing the effectiveness of the electrostatic section 106. To potentially reduce the probability of shorts or arcing, the negative plate 130B includes rounded edges 208A and 208B. The rounded edges 208A and 208B reduce the probability of a local charge density at portions of the negative plate 130B. In some examples, the positive plate 130A may also be configured with rounded edges.

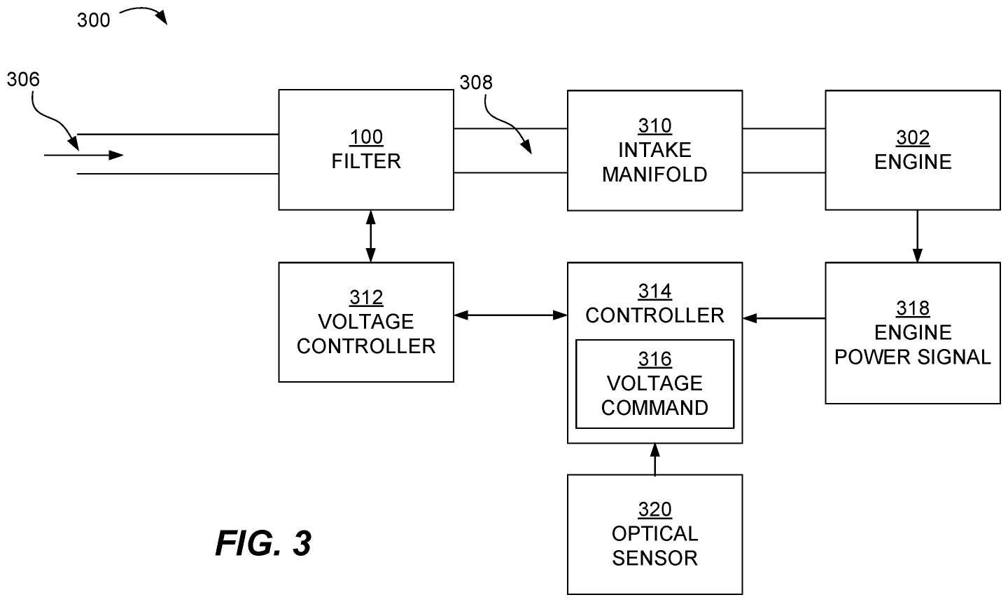

As mentioned above, the voltages of the positive plate 130A and/or the negative plate 130B may be adjusted to reduce a probability of arcing or shorting from the positive plate 130A to the negative plate 130B. As illustrated in FIG. 2, the positive plate 130A may be connected to power source 210 and the negative plate 130B is grounded, providing the voltage potential as measured between the positive plate 130A and the negative plate 130B across the air precleaner 100 to provide for a supplemental force using electrostatic attraction and repulsion. The voltages may also be adjusted for other reasons, illustrated in more detail in FIG. 3, below.

FIG. 3 is an illustration of a precleaning system 300 in which the air precleaner 100 of FIG. 1 is used to clean air for an internal combustion engine (“engine”) 302, in accordance with various example of the presently disclosed subject matter. The engine 302 can be configured to combust various fuels, including, but not limited to, gasoline, diesel distillate fuel, dimethyl ether, biodiesel, Hydrotreated Vegetable Oil (HVO), Gas to Liquid (GTL) renewable diesel, methanol, or ethanol, or still other fuel types. The air precleaner 100 receives unfiltered air 306, filters the unfiltered air 306 explained by example in FIG. 1 or 2, above, and provides filtered air 308 to an intake manifold 310. The intake manifold 310 distributes the filtered air 308 to cylinders (not shown) of the engine 302. As noted above in FIG. 2, the voltages applied to the air precleaner 100 may be adjusted for various reasons. For example, the voltages applied to the air precleaner 100 may be maintained at a level to reduce the probability of arcing or shorts in the air precleaner 100. The voltages of the air precleaner 100 are adjusted by a voltage controller 312. The voltage controller 312 increases or decreases the voltages applied to the air precleaner 100.

The voltage controller 312 is controlled by a controller 314. The controller 314 can be a component of an engine control unit (ECU), engine control module (ECM) ECU of an internal combustion engine, or another component used to control various aspects of an internal combustion engine. Along with other functions, the controller 314 issues commands to the voltage controller 312 to increase, maintain, or reduce the voltages applied to the air precleaner 100. The controller 314 includes one or more processors and memory storing therein instructions that, when executed by the processor of the controller 314, cause the controller 314 to issue a voltage command 316 to the voltage controller 312 to increase, maintain, or reduce the voltages applied to the air precleaner 100.

Additionally, the controller 314 includes one or more transceivers or input/output devices used to receive various input signals from the filtering system 300 to control the voltage controller 312. For example, the controller 314 may receive an engine power signal 318 from the engine 302 or another component of the filtering system 300, including the controller 314 itself. The engine power signal 318 is a signal indicating a power level, or intended power level, of the engine 302. Various power levels of the engine 302 may require different flowrates the filtered air 308 to supply a correct amount of the filtered air 308 for combustion. Differing flowrates of the filtered air 308 may require an increase or allow for a decrease in voltages applied to the air precleaner 100. If an increase in flowrate is required, the air precleaner 100 may need an increase in the voltage applied to the air precleaner 100 to compensate for the increased amount of unfiltered air 306 and particulate moving through the air precleaner 100. Similarly, if a decrease in flowrate is required due to a lower power requirement indicated by the engine power signal 318, the air precleaner 100 may reduce the voltage to save energy or for other reasons because a lower flowrate of the unfiltered air 306 likely would correspond to a lower amount of particulate moving through the air precleaner 100.

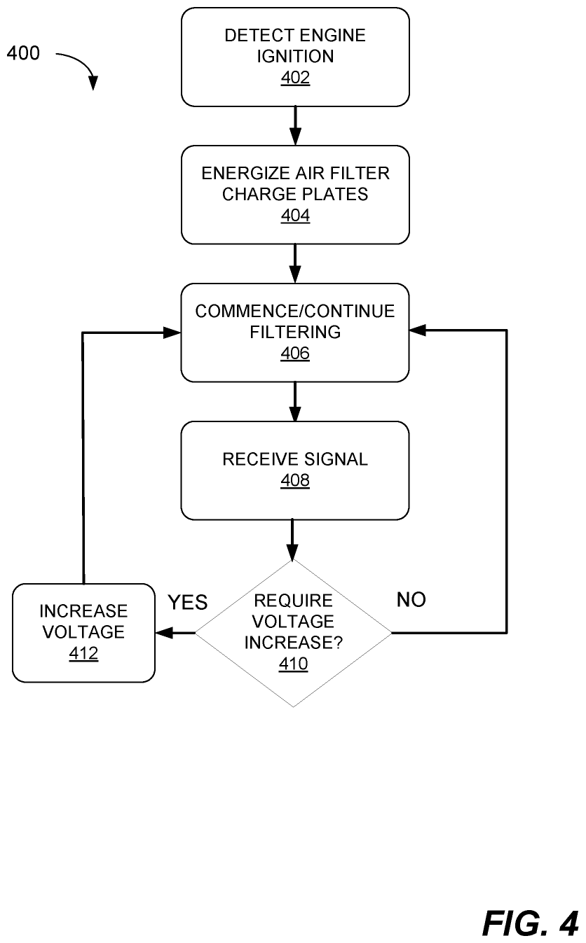

In another example, the controller 314 may receive an input from an optical sensor 320. The optical sensor 320 may be configured to detect the presence of particulates in the filtered air 308 or the particle exhaust 120. Other types of particulate sensors may be used and are considered to be within the scope of the presently disclosed subject matter. The optical sensor 320 can be used to determine the concentration, presence, or amount of particulate in the air precleaner 100, exiting the air precleaner 100, and the like. The controller 314 may receive an input from the optical sensor 320 indicating a concentration of particulate in various portions of the filtering system 300, such as the filtered air 308. If the concentration is above a setpoint, the controller 314 can issue the voltage command 316 to increase the voltages applied to the air precleaner 100 to attempt to increase the ionization of particles in the air precleaner 100, thus increasing the effectiveness of the filter. An example of a process for controlling the voltage applied to the air precleaner 100 is provided in FIG. 4, below.

FIG. 4 illustrates a method 400 for operating the filtering system 300, in accordance with various examples of the presently disclosed subject matter. The method 400 and other processes described herein are illustrated as example flow graphs, each operation of which may represent a sequence of operations that can be implemented in hardware, software, or a combination thereof. In the context of software, the operations represent computer-executable instructions stored on one or more tangible computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

The method 400 commences at step 402, where the controller 314 receives a signal indicating that the engine 302 is starting up, and thus, requiring the filtered air 308. To provide the filtered air 308, the air precleaner 100 of FIG. 1 is used.

The method 400 continues to step 404, where the controller 314 issues the voltage command 316 to the voltage controller 312. As noted above, the voltage controller 312 controls the voltage applied to the positive plate 130A and/or the negative plate 130B of the air precleaner 100.

The method 400 continues to step 406, after the positive plate 130A and/or the negative plate 130B of the air precleaner 100 are energized pursuant to step 404, the air precleaner 100 commences filtering the air to provide the filtered air 308 to the engine 302.

The method 400 continues to step 408, where the controller 314 receives a signal that may require a change in the voltage applied to the air precleaner 100. For example, the signal may be the engine power signal 318 indicating a power level of the engine 302. The controller 314 uses the power level to determine the voltage applied to the air precleaner 100. In another example, the signal may be from the optical sensor 320 indicating that the controller 314 may need to adjust the voltage applied to the air precleaner 100 to increase the ionization of particulate moving through the filter.

The method 400 continues to step 410, where the controller 314 determines if the voltage applied to the air precleaner 100 needs to be adjusted. If at step 410, the controller 314 determines that the voltage applied to the air precleaner 100 needs to be adjusted, the method continues to step 412, where the controller 314 issues the voltage command 316 to the voltage controller 312 to change the voltage applied to the air precleaner 100. If at step 410, the controller 314 determines that the voltage applied to the air precleaner 100 does not need to be adjusted, the method 400 continues to step 406.

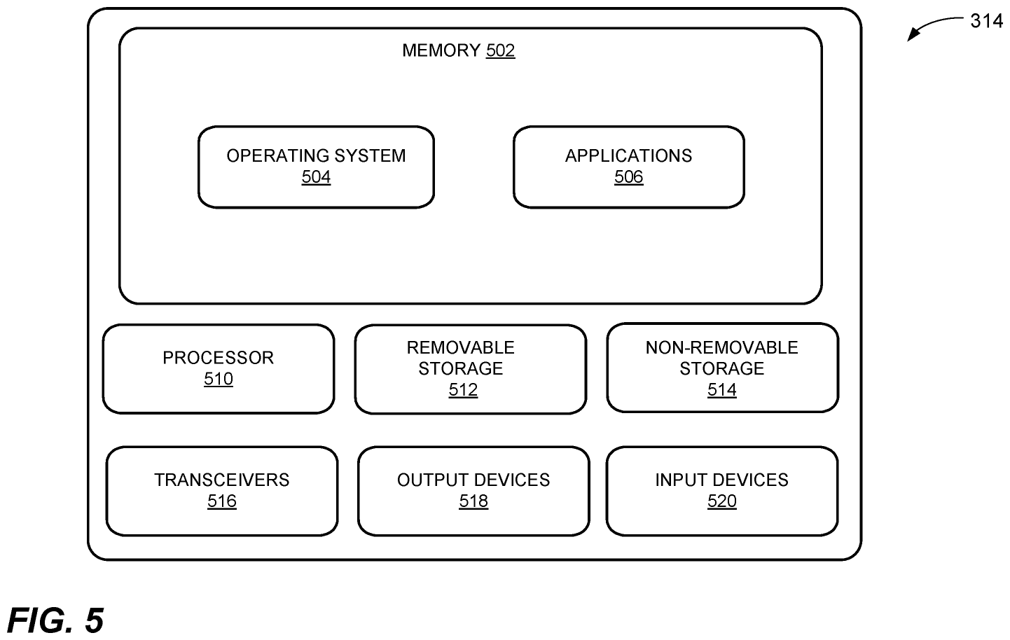

FIG. 5 depicts a component level view of the controller 314 for use with the systems and methods described herein, in accordance with various examples of the presently disclosed subject matter. The controller 314 could be any device capable of providing the functionality associated with the systems and methods described herein. The controller 314 can comprise several components to execute the above-mentioned functions. The controller 314 may be comprised of hardware, software, or various combinations thereof. As discussed below, the controller 314 can comprise memory 502 including an operating system (OS) 504 and one or more standard applications 506. The standard applications 506 may include applications that provide for receiving signals such as the engine power signal 318 and issuing the voltage command 316.

The controller 314 can also comprise one or more processors 510 and one or more of removable storage 512, non-removable storage 514, transceiver(s) 516, output device(s) 518, and input device(s) 520. In various implementations, the memory 502 can be volatile (such as random-access memory (RAM)), non-volatile (such as read only memory (ROM), flash memory, etc.), or some combination of the two. The memory 502 can include data stored on a remote server or a cloud of servers accessible by the controller 314.

The memory 502 can also include the OS 504. The OS 504 varies depending on the manufacturer of the controller 314. The OS 504 contains the modules and software that support basic functions of the controller 314, such as scheduling tasks, executing applications, and controlling peripherals. The OS 504 can also enable the controller 314 to send and retrieve other data and perform other functions, such as transmitting control signals using the transceivers 516 and/or output devices 518 and receiving signals using the input devices 520.

The controller 314 can also comprise one or more processors 510. In some implementations, the processor(s) 510 can be one or more central processing units (CPUs), graphics processing units (GPUs), both CPU and GPU, or any other combinations and numbers of processing units. The controller 314 may also include additional data storage devices (removable and/or non-removable) such as, for example, magnetic disks, optical disks, or tape. Such additional storage is illustrated in FIG. 5 by removable storage 512 and non-removable storage 514.

Non-transitory computer-readable media may include volatile and nonvolatile, removable and non-removable tangible, physical media implemented in technology for storage of information, such as computer readable instructions, data structures, program modules, or other data. The memory 502, removable storage 512, and non-removable storage 514 are all examples of non-transitory computer-readable media. Non-transitory computer-readable media include, but are not limited to, RAM, ROM, electronically erasable programmable ROM (EEPROM), flash memory or other memory technology, compact disc ROM (CD-ROM), digital versatile discs (DVD) or other optical storage, magnetic cassettes, magnetic tape, magnetic disk storage or other magnetic storage devices, or any other tangible, physical medium which can be used to store the desired information, which can be accessed by the controller 314. Any such non-transitory computer-readable media may be part of the controller 314 or may be a separate database, databank, remote server, or cloud-based server.

In some implementations, the transceiver(s) 516 include any transceivers known in the art. In some examples, the transceiver(s) 516 can include wireless modem(s) to facilitate wireless connectivity with other components (e.g., between the controller 314 and a wireless modem that is a gateway to the Internet), the Internet, and/or an intranet. Specifically, the transceiver(s) 516 can include one or more transceivers that can enable the controller 314 to send and receive data. Thus, the transceiver(s) 516 can include multiple single-channel transceivers or a multi-frequency, multi-channel transceiver to enable the controller 314 to send and receive video calls, audio calls, messaging, etc. The transceiver(s) 516 can enable the controller 314 to connect to multiple networks including, but not limited to 2G, 3G, 4G, 5G, and Wi-Fi networks. The transceiver(s) 516 can also include one or more transceivers to enable the controller 314 to connect to future (e.g., 6G) networks, Internet-of-Things (IoT), machine-to machine (M2M), and other current and future networks.

The transceiver(s) 516 may also include one or more radio transceivers that perform the function of transmitting and receiving radio frequency communications via an antenna (e.g., Wi-Fi or Bluetooth®). In other examples, the transceiver(s) 516 may include wired communication components, such as a wired modem or Ethernet port, for communicating via one or more wired networks. The transceiver(s) 516 can enable the controller 314 to facilitate audio and video calls, download files, access web applications, and provide other communications associated with the systems and methods, described above.

In some implementations, the output device(s) 518 include any output devices known in the art, such as a display (e.g., a liquid crystal or thin-film transistor (TFT) display), a touchscreen, speakers, a vibrating mechanism, or a tactile feedback mechanism. Thus, the output device(s) can include a screen or display. The output device(s) 518 can also include speakers, or similar devices, to play sounds or ringtones when an audio call or video call is received. Output device(s) 518 can also include ports for one or more peripheral devices, such as headphones, peripheral speakers, or a peripheral display.

In various implementations, input device(s) 520 include any input devices known in the art. For example, the input device(s) 520 may include a camera, a microphone, or a keyboard/keypad. The input device(s) 520 can include a touch-sensitive display or a keyboard to enable users to enter data and make requests and receive responses via web applications (e.g., in a web browser), make audio and video calls, and use the standard applications 506, among other things. A touch-sensitive display or keyboard/keypad may be a standard push button alphanumeric multi-key keyboard (such as a conventional QWERTY keyboard), virtual controls on a touchscreen, or one or more other types of keys or buttons, and may also include a joystick, wheel, and/or designated navigation buttons, or the like. A touch sensitive display can act as both an input device 520 and an output device 518.

### INDUSTRIAL APPLICABILITY

The present disclosure relates generally to the use of electrostatic charges to provide a supplementary force to filter particulate in air provided to an internal combustion engine. The air precleaner 100 uses the positive plate 130A and the negative plate 130B to provide ions to ionize particles in the air 112 moving through the air precleaner 100. The ionized particles are attracted to a potential field of the opposite polarity and repulse from a potential field of the same polarity. The electrostatic attraction/repulsion applies a force to smaller particles having less mass that may otherwise be relatively unaffected by the centripetal force created by the cyclonic section 104. A portion of the ionized particles are force to the inner wall 126 of the air precleaner 100 where the particles eventually exit the air precleaner 100 through the particle exhaust 120.

Along with filtering air, the air precleaner 100 can provide various advantages in some configurations. For example, rather than electrostatically attracting particulate to collection plates, which would require continual cleaning, the air precleaner 100 uses the movement of the air to move particulate either centripetally forced or electrostatically force to the inner wall 126 to the particle exhaust 120, providing for a continual cleaning and removing particulate from the air precleaner 100. Additionally, the removal of particles using both centripetal force and electrostatic force can increase the amount of particle exhausted through the particle exhaust 120 rather than being trapped in the secondary filter 122, potentially reducing costs associated with cleaning or replacing the secondary filter 122.

Unless explicitly excluded, the use of the singular to describe a component, structure, or operation does not exclude the use of plural such components, structures, or operations or their equivalents. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of what is disclosed. Such embodiments should be understood to fall within the scope of the present disclosure as determined based upon the claims and any equivalents thereof.

What is claimed is:

1. An air precleaner for precleaning air used for an internal combustion engine, the air precleaner comprising:
an intake section for receiving air from an environment around the air precleaner, wherein the air includes particles;
an electrostatic section comprising:
a positive plate having a positive voltage potential, wherein the positive plate is disposed proximate to an inner wall of the air precleaner, the positive plate configured to create a positive charge field proximate to the inner wall of the air precleaner, wherein the positive charge field is configured to ionize at least a first portion of the particles moving through the air precleaner with a positive charge; and
a negative plate having a negative voltage potential relative to the positive voltage potential of the positive plate, wherein the negative plate is disposed proximate to the inner wall of the air precleaner and electrically separated from the positive plate and configured create a negative charge field proximate to the inner wall of the air precleaner, wherein the negative charge field is configured to ionize at least a second portion of the particles moving through the air precleaner with a negative charge, wherein the first portion of the particles are electrostatically attracted to the negative plate and the second portion of the particles are electrostatically attracted to the positive plate to electrostatically force at least a portion of the first portion and at least a portion of the second portion towards the inner wall of the air precleaner;
an air exhaust for allowing the air to exit the air precleaner; and
a particle exhaust for allowing a portion of the particles ionized by the positive charge field or the negative charge field to exit the air precleaner.

2. The air precleaner of claim 1, further comprising a cyclonic section configured to cause the air entering the air precleaner to rotate about a central axis of the air precleaner, imparting a centripetal force on at least a portion of the particles to force the at least a portion of the particles to inner wall of the air precleaner.

3. The air precleaner of claim 2, wherein the cyclonic section comprises a plurality of blades that cause the air to rotate.

4. The air precleaner of claim 1, further comprising a second filter configured to filter a third portion of the particles exiting the air precleaner through the air exhaust.

5. The air precleaner of claim 1, wherein the positive plate or the negative plate comprises a rounded edge configured to reduce a probability of creating a local charge density at portions of the positive plate or the negative plate.

6. The air precleaner of claim 1, further comprising a controller, wherein the controller is configured to issue a voltage command to a voltage controller to change the positive voltage potential or the negative voltage potential.

7. The air precleaner of claim 6, wherein the controller is further configured to:
receive a signal to indicate a change in a flowrate of the air;
determine if the positive voltage potential or the negative voltage potential needs to be changed based on the change in the flowrate; and
upon determining that the positive voltage potential or the negative voltage potential needs to be changed, issue a second voltage command to the voltage controller to change the positive voltage potential or the negative voltage potential.

8. The air precleaner of claim 7, wherein the signal to indicate a change in the flowrate comprises an engine power signal indicating a power level of the engine.

9. The air precleaner of claim 6, wherein the controller is further configured to:
receive an input from a sensor configured to detect an amount of the particles exiting the air precleaner through the air exhaust;
determine if the positive voltage potential or the negative voltage potential needs to be changed based on the input from the sensor; and
upon determining that the potential needs to be changed, issue a second voltage command to the voltage controller to change the positive voltage potential or the negative voltage potential.

10. The air precleaner of claim 9, wherein an increase in the positive voltage potential or the negative voltage potential is configured to increase an amount of the particles that are ionized by the positive charge field or the negative charge field.

11. A controller for controlling an air precleaner for an internal combustion engine, the controller comprising:
a memory storing computer-executable instructions; and
a processor in communication with the memory, the computer-executable instructions causing the processor to perform acts comprising:
detecting the engine is starting up requiring air for combustion, wherein the air includes particles; and
issuing a voltage command to a voltage controller of an air precleaner to preclean the air, wherein the air precleaner comprises:
a positive plate disposed proximate to an inner wall of the air precleaner, the positive plate configured to create a positive charge field proximate to the inner wall of the air precleaner, wherein the positive charge field is configured to ionize at least a first portion of the particles moving through the air precleaner with a positive charge; and
a negative plate disposed proximate to the inner wall of the air precleaner and electrically separated from the positive plate and configured create a negative charge field proximate to the inner wall of the air precleaner, wherein the negative charge field is configured to ionize at least a second portion of the particles moving through the air precleaner with a negative charge, and wherein the first portion of the particles are electrostatically attracted to the negative plate and the second portion of the particles are electrostatically attracted to the positive plate, and wherein the voltage command controls a voltage potential as measured between the positive plate and the negative plate.

12. The controller of claim 11, further comprising computer-executable instructions to cause the processor to perform the acts comprising:
receiving a signal to indicate a change in a flowrate of the air for combustion;
determining if the voltage potential needs to be changed; and
upon determining that the voltage potential needs to be changed, issuing a second voltage command to the voltage controller to change the voltage potential.

13. The controller of claim 12, wherein the signal to indicate a change in the flowrate comprises an engine power signal indicating a power level of the engine.

14. The controller of claim 11, further comprising computer-executable instructions to cause the processor to perform the acts comprising:
receiving an input from a sensor configured to detect an amount of the particles exiting the air precleaner;
determining if the voltage potential needs to be changed based on the input from the sensor; and
upon determining that the voltage potential needs to be changed, issuing a second voltage command to the voltage controller to change the voltage potential.

15. The controller of claim 14, wherein an increase in the voltage potential is configured to increase an amount of the particles that are ionized by the positive charge field or the negative charge field.

16. An air precleaner system for precleaning air for an internal combustion engine, the air precleaner system comprising:
an air precleaner comprising:
an intake section for receiving the air from an environment around the air precleaner, wherein the air includes particles;
an electrostatic section comprising:
a positive plate having a positive voltage potential, wherein the positive plate is disposed proximate to an inner wall of the air precleaner, the positive plate configured to create a positive charge field proximate to the inner wall of the air precleaner, wherein the positive charge field is configured to ionize at least a first portion of the particles moving through the air precleaner with a positive charge; and
a negative plate having a negative voltage potential relative to the positive voltage potential of the positive plate, wherein the negative plate is disposed proximate to the inner wall of the air precleaner and electrically separated from the positive plate and configured create a negative charge field proximate to the inner wall of the air precleaner, wherein the negative charge field is configured to ionize at least a second portion of the particles moving through the air precleaner with a negative charge, and wherein the first portion of the particles are electrostatically attracted to the negative plate and the second portion of the particles are electrostatically attracted to the positive plate to electrostatically force at least a portion of the first particles and at least a portion of the second portion towards the inner wall of the air precleaner; and
a controller comprising:
a memory storing computer-executable instructions; and
a processor in communication with the memory, the computer-executable instructions causing the processor to perform acts comprising:
receiving a signal to indicate a change in a flowrate of the air;
determining if the positive voltage potential or the negative voltage potential needs to be changed based on the change in the flowrate; and
upon determining that the positive voltage potential or the negative voltage potential needs to be changed, issuing a second voltage command to the voltage controller to change the positive voltage potential or the negative voltage potential.

17. The air precleaner system of claim 16, wherein the computer-executable instructions further include computer-executable instructions that cause the processor to perform acts comprising:
receiving an input from a sensor configured to detect an amount of the particles exiting the air precleaner through an air exhaust or a particle exhaust of the air precleaner;
determining if the positive voltage potential or the negative voltage potential needs to be changed based on the input from the sensor; and
upon determining that the positive voltage potential or the negative voltage potential needs to be changed, issuing a second voltage command to the voltage controller to change the positive voltage potential or the negative voltage potential.

18. The air precleaner system of claim 16, wherein the air precleaner further comprises:
an air exhaust for allowing the air to exit the air precleaner; and
a particle exhaust for allowing a portion of the particles ionized by the positive charge field or the negative charge field to exit the air precleaner.

19. The air precleaner system of claim 16, wherein the air precleaner further comprises a cyclonic section configured to cause the air entering the air precleaner to rotate about a central axis of the air precleaner, imparting a centripetal force on at least a portion of the particles to force the at least a portion of the particles to inner wall of the air precleaner, wherein the centripetal force is a primary force to preclean the particles and a supplemental force to preclean the particles is provided by the electrostatic attraction of the first portion and the second portion to the positive charge field or the negative charge field.

20. The air precleaner system of claim 16, wherein the air from the environment around the air precleaner further comprises a plurality of positively charged particles or a plurality of negatively charged particles, wherein at least a portion of the positively charged particles are attracted to the negative plate and are repulsed by the positive plate, and further wherein at least a portion of the negatively charged particles are attracted to the positive plate and are repulsed by the negative plate.
